(19) United States
(12) Patent Application Publication
(10) Pub. No.: US 2007/0115551 A1
(43) Pub. Date: May 24, 2007

(54) Space-variant waveplate for polarization conversion, methods and applications

(76) Inventors: Alexis Spilman, Rochester, NY (US); Thomas G. Brown, Rochester, NY (US)

Correspondence Address: BOND, SCHOENECK & KING, PLLC, 10 BROWN ROAD, SUITE 201, ITHACA, NY, 14850-1248, US

(21) Appl. No.: 11/395,978

(22) Filed: Mar. 31, 2006

Related U.S. Application Data
(60) Provisional application No. 60/667,232, filed on Apr. 1, 2005.

(51) Int. Cl. G02B 5/30

(52) U.S. Cl. 359/494; 359/483

(57) ABSTRACT

Embodiments of the invention are directed to apparatus and methods for converting spatially homogeneously polarized light into spatially inhomogeneously polarized light having a fast axis orientation that varies in a smooth and continuous manner over a pupil aperture. A space-variant waveplate referred to herein as a polarization converter includes an optically transmissive window characterized by a symmetric stress birefringence that provides at least λ/4 retardance and, more particularly, λ/2 retardance over an annular region centered about the optical axis of the window. Structural embodiments of the polarization converter include a mechanical compression housing and a thermal compression housing. Radially and azimuthally polarized vortex beams including cylindrical vector beams and counter-rotating beams can be generated from uniformly plane polarized input beams propagating through the polarization converter. Low-order polarization vortex beams can be optically combined to produce higher-order scalar vortex beams. Embodiments of the invention are also directed to various optical illumination and imaging systems utilizing the apparatus and methods described herein.

### RELATED APPLICATION DATA

This application claims the benefit of priority of Provisional Application Ser. No. 60/667,232 filed on Apr. 1, 2005, the entire disclosure of which is incorporated herein by reference.

### FEDERALLY SPONSORED RESEARCH

Not applicable.

### BACKGROUND OF THE INVENTION

1. Field of the Invention

Embodiments of the invention are most generally related to the field of polarized light, including its generation and conversion. More particularly, embodiments of the invention are directed to novel polarization conversion devices and methods, optical systems employing such devices, and applications utilizing such devices, methods and systems.

2. Description of Related Art

Homogeneously polarized light can be thought of as light having a polarization state that is spatially uniform across the pupil of the polarizer. Linearly polarized light, that is, light for which the spatial orientation of its electric field lies entirely within one plane, is an example of homogeneously polarized light. Circular and elliptical polarizations are further examples of homogeneously polarized light.

Homogeneous polarized light is used in a variety of different applications. For example, homogeneous polarized light is used in various microscopy techniques to improve the visibility of objects that are not easily seen with conventional microscopes. Conventional microscopes with crossed polarizers, phase contrast microscopes and Differential Interference Contrast microscopes all advantageously utilize homogeneous polarized light. These microscopes produce images which transform round-trip optical path differences or local anisotropy in the sample to intensity variations in the image.

In an optical system for microscopy applications, for example, the illumination system is of paramount importance. By optimizing the illumination design optical resolution of an imaging system can significantly be enhanced. For highly demanding applications, such as nanoscale imaging, for example, the illumination system may employ a laser beam adapted for telecentric scanning across the object. When the scattered laser light is collected and detected, it may be converted into an electronic image. If the detector is situated behind a pinhole conjugate to the object plane, the detection is said to be confocal. By suitable light scanning and sample translation, confocal detection may provide extremely high resolution, three dimensional imaging of biological samples. It may also be used to provide precise characterization of reticles or precise measurements of printed line widths in semiconductor lithography applications. In many cases, it is desirable to use a polarized illumination source for improved contrast and resolution. The components and operation of these microscopes are well known as set forth, for example, in The Principles of Scanning Confocal Microscopy by T. H. Wilson, which is incorporated herein by reference.

An extremely important area of technology is that of semiconductor patterning in the filed of optical lithography. An optical lithography system is one which uses light to transfer a prescribed pattern to a photoresist film in contact with a semiconductor wafer or similar substrate. Patterning, and similar, optical systems frequently employ homogeneously polarized illumination. In scanning lithography, for example, a polarized laser is often used. For image-based lithography, an entire pattern is transferred in a single exposure. In scanning or direct-write lithography, the pattern is sequentially applied, image point by image point, or image line by image line. Since ultra-precise imaging is so important in optical lithography, patterning systems arguably are, end-to-end, the most precisely engineered optical systems available. The imaging optical path in particular, being considered the most critical path in such a system, has typically been the focus of technological attention. The design specifications of these systems generally require a pupil polarization that is either homogeneous or assembled from a collection of homogeneous segments. More and more, however, innovative illumination path design is being recognized as key to better imaging.

In the past, inhomogeneously polarized light has not been considered for use in many applications, including lithography and optical imaging systems, such as microscopes for the inspection of semiconductor wafers, phase shift masks and reticles. As used herein and discussed in greater detail below, the term “inhomogeneous polarization” will be used to refer to light having a polarization state that is not spatially uniform across the pupil of the polarizer. It has become clear that pupil illumination with a polarization that varies spatially and in a continuous manner throughout the pupil offers many advantages, including higher resolution and higher longitudinally polarized fields at the focus of the condenser. Recently, for example, the use of inhomogeneous (e.g., azimuthal) polarization has been identified as critical for 193 nm immersion lithography.

Inhomogeneous Polarization

A. Polarization Vortex Beams

Azimuthal and radial beams are two examples of polarization vortices. An optical vortex is a point which exhibits a phase anomaly such that the field evolves through a phase of 2π (or multiple thereof) in any circular path traced about that point. This path is generally chosen in the target plane of an illumination system. A polarization vortex is a linearly polarized state in which the direction of polarization similarly evolves through a multiple of 2π about the beam axis. A “polarization vortex beam,” as that term is used herein, will refer to optical vortex beams that show a smooth (as opposed to discrete) change in polarization direction through a multiple of 2π radians when traversing a closed loop (e.g., a circular path) about the axis of the beam. Radial and azimuthal polarizations are examples of two lowest-order optical vortex beams; linear combinations of these can be used to provide a variety of other polarization patterns.

Cylindrical vector (CV) beams are a class of polarization vortex beams. While conventional beams are low-order and of Gaussian shape, CV beams correspond to higher order modes of the field. CV beams are derived from the free-space vector wave equation for the electric and magnetic fields [1]:
∇×∇×E=k²E ∇×∇×H=k²H
Radially and azimuthally polarized fields are single mode solutions to the above vector wave equations. These solutions have been studied by Jordan and Hall [2], Hall [3], Greene and Hall [4-6], and Sheppard [7]. Both the azimuthal electric field solutions and azimuthal magnetic field solutions possess a magnetic field component and a radial field component, respectively, that is oriented in the radial and longitudinal directions. CV beams can be decomposed into linear combinations of azimuthal and radial polarization. FIG. 1 illustrates the polarization orientation of the azimuthal (a) and radial (b) solutions. The polarization direction in optics is usually specified by the direction of the electric field, as shown by the arrows. Because CV beams have polarization vectors that are cylindrically symmetric about the optical axis, a phase vortex exists at the center of the beam, and an on-axis null results.

FIGS. 2a and 2b illustrate the relationship between the electric and magnetic fields for the radial and azimuthal beams of FIGS. 1a, 1b. The azimuthal electric field will have a radial magnetic field and vice versa.

Greene and Hall [3,4,7] studied the propagation and focusing properties of light in the paraxial regime. Youngworth and Brown [8] extended this work to explore high numerical aperture (NA) focusing characteristics of both azimuthally and radially polarized light, and Biss and Brown [9] calculated the effects of a dielectric interface. Quabis and coworkers [10-11] have also presented theoretical calculations for the high NA focusing of radially polarized light and showed that the longitudinal component of a radially polarized beam has a smaller focal spot than a linearly polarized beam for beams focusing at high NAs. Radially polarized beams possess a localized, intense field component that is polarized longitudinally, or in the direction of propagation, through the focus. Radially polarized CV beams also possess a less intense radially polarized component. The longitudinal field at focus from a radially polarized beam can be used to perform imaging with increased resolution. A radially polarized beam creates a significantly stronger longitudinal field than a uniformly polarized beam near focus, so by choosing an appropriate mechanism that interacts exclusively with the longitudinal component of a radially polarized beam, the point spread function can be reduced and the resolution of the system increased. Thus the longitudinal field component generated by the focused radial beam is of great interest in microscopy.

Azimuthally polarized beams are characterized by an annular focal region that maintains its purely transverse components in both paraxial and high angle focusing regimes. FIGS. 3a, 3b, 3c and 3d show images of an azimuthally polarized beam taken with a CCD camera. The annular shape of the azimuthal beam is shown in the image of the beam (a), but linear polarizers are needed to determine the polarization of the beam. Images (b), (c), and (d) illustrate the intensity pattern of the beam after it passes through a linear polarizer in three different orientations. With the original beam azimuthally polarized, the beam after the linear polarizer has a double lobe intensity pattern with the dark region between the lobes oriented in the same direction as the polarizer. If there were no distinguishing lobes, then a CV beam would not be present.

In addition to azimuthally and radially polarized CV beams, as described above, another type of polarization vortex beams, called ‘counter-rotating’ beams, can be created. FIGS. 4a and 4b show a counter-rotating radial beam (a) and a counter-rotating azimuthal beam (b). These counter-rotating beams are inhomogeneously polarized, but are not cylindrical vector beams. For counter-rotating beams, the local polarization rotates in a direction opposite the path around the center of a cross-section of the beam.

Combining two Hermite-Gauss modes can also create cylindrical vector beams [8,13]. As shown in FIG. 5, two HG₁₀ modes of orthogonal polarization generate a radially polarized CV beam. Two HG₀₁ modes of orthogonal polarization generate an azimuthally polarized CV beam as shown in FIG. 6. The counter-rotating polarization beams can be generated in a similar fashion with the same superposition, but with one of the HG modes phase shifted. FIG. 7 illustrates the formation of a counter-rotating radially polarized beam with two orthogonal HG₁₀ modes. Combining two orthogonal HG₀₁ modes can generate a counter-rotating azimuthally polarized beam as shown in FIG. 8.

B. Focusing CV beams

The effects of focusing radially and azimuthally polarized beams with large numerical apertures have previously been studied [8,14]. When a focused radially polarized beam is incident on an interface between two surfaces with differing dielectric constants, an amplitude discontinuity of the longitudinal field component of the radially polarized beam is observed. This amplitude discontinuity corresponds with an enhancement of the longitudinal field on the side of the interface that has a lower dielectric constant. When a radially polarized beam is focused through an interface, from a high index material to a low index material, the longitudinal field component remains much more tightly confined than the radially polarized component or linearly circularly polarized beams. This longitudinal field component of radially polarized cylindrical vector beams aids in the imaging of dipoles. Dipoles oriented in the longitudinal direction are difficult to image with focused linearly polarized light, but with focused radially polarized light they become much easier to image because of the strong longitudinal field that exists at a high focusing numerical aperture.

C. Generating Inhomogeneously Polarized Illumination

Methods of converting ordinary homogenously polarized beams into inhomogeneously polarized beams currently exist. Lasers [15], such as the concentric-circle-grating surface-emitting (“CCGSE”) semiconductor laser, can be used to generate azimuthally polarized light. Unfortunately, it is not easy to control which of the many possible azimuthal modes will be emitted by the CCGSE laser. As a result, the azimuthally polarized light produced using CCGSE lasers are of little use.

Holograms [16], liquid crystal methods [17] and fibers [18] have also been used to produce optical beams with inhomogeneous polarization. These methods are expensive and difficult to fabricate, or produce beams of inferior quality.

Youngworth et al., in co-pending U.S. patent application Ser. No. 09/759,91, the entire disclosure of which is hereby incorporated by reference, describe an interferometric method of converting an ordinary (e.g. linearly) polarized beam into an inhomogeneously polarized beam, such as a cylindrical vector beam [see also 19-20]. In the interferometric method as disclosed therein, an input beam is polarized with a mixture of horizontal and linear polarizations. The two orthogonal components are separated and one half of each beam is phase shifted. The position of each phase shifter depends on the desired beam at the output. The phase shifting element is used to create a beam such that half of the beam has a π phase shift with respect to the other half. The two orthogonal beams are then coherently superimposed to yield an inhomogeneously polarized beam. Depending on the types of elements in the converter, the output beam may need to be spatially filtered in order to assure the lowest order mode of the CV beam. To generate a radially polarized beam, the upper and lower halves of the vertically polarized beam are phase shifted and the left and right halves of the horizontally polarized beam are phase shifted. To generate an azimuthally polarized beam, the left and right halves of the vertically polarized beam are phase shifted and the upper and lower halves of the horizontally polarized beams are phase shifted.

Interferometric techniques used to generate CV beams include using a Mach-Zehnder interferometer, a Twyman-Green interferometer, and common-path interferometers [12]. The common-path Mach-Zehnder mode converter has many advantages over other interferometric techniques in that it is small (the size of a one-inch lens or polarizing optic), it is a single optical element, it is more mechanically stable, it does not require realignment when in a cemented form, and it is cost-effective. The interferometric method, however, suffers from the tendency of Mach-Zehnder and Twyman Green/Michelson interferometers to drift, requiring regular adjustment to maintain the quality of the beam in the pupil. This method also requires laser beams of high coherence, making the use of pulsed lasers and semiconductor lasers difficult.

Spiral wave plates, diffractive elements in interferometers, and liquid crystal spatial light modulators and fibers, have also been used to produce optical beams with inhomogeneous polarization. Each of these are either expensive and difficult to fabricate, or produce beams of inferior quality.

The inventors have further explored alternative techniques for converting polarized beams into inhomogeneously polarized beams using mica with half-wave retardance at 532 nm, 650 nm, and 800 nm. Pieces of mica were cut into pie-shaped segments and then recombined in specific orientations. Unfortunately, mica proved challenging for cutting clean edges because it flakes very easily. The inventors then observed that under certain conditions, a specific type of Staples® brand transparent tape exhibited half-wave retardance near 800 nm. The tape was arranged into an eight-piece segmented waveplate with half-wave sections. FIG. 9 illustrates a schematic of the tape-segmented waveplate where the lines within each section mark the fast axis of each segment. The half-wave segmented tape waveplate was found to produce a mode that could be manipulated to form radial and azimuthal polarizations with the addition of a linear polarizer. Opposite segments have fast axes that are perpendicular, and therefore yield pupils that have fields which are out of phase on opposite sides of the optical axis. Although polarization conversion is accomplished, it is obtained by dividing the beam into individual segments in a discrete manner.

Despite the aforementioned methods and apparatus for successfully converting a beam of homogeneous (uniform) polarization into a beam of inhomogeneous polarization, the inventors have recognized a need for an apparatus and method that can simply, efficiently and effectively provide polarization conversion of a beam of homogeneous polarization to one of inhomogeneous polarization which varies over the pupil in a smooth and continuous manner. In accordance therewith, the inventors have also recognized that there are benefits and advantages associated with the use of such apparatus and methods in optical systems, particularly the illumination path of optical imaging systems, used for optical lithography, microscopy, semiconductor inspection, reticule and mask design, and others that will be appreciated by persons skilled in the art.

The advantages and benefits provided by the teachings disclosed herein and the embodiments of the invention disclosed and claimed will become more apparent to persons skilled in the art in view of the following description and drawings.

### SUMMARY OF THE INVENTION

Embodiments of the invention are directed to novel polarization conversion devices and methods, optical systems employing such devices, and applications utilizing such devices, methods and systems.

According to an embodiment of the invention, a polarization converter includes an optically transparent window having a clear aperture defined by opposing, polished faces and a periphery. The window is characterized by having an induced symmetric stress birefringence pattern over at least a portion of the clear aperture that is sufficient to produce an optical retardance equal to or greater than a quarter wavelength, and more particularly equal to a half-wavelength. The stress birefringence pattern has an N-fold symmetry, where N is an integer greater than 2. In a particular aspect, N=3, which defines a tri-fold symmetry pattern. The opposing, polished faces have an optical quality sufficient to transmit a plane wavefront, thereby not introducing unwanted phase distortions to a beam propagating through the window.

In an aspect, the polarization converter is controllably mechanically stressed to induce the symmetric stress birefringence pattern in the window. According to this aspect, a stress transfer sleeve surrounds the window periphery and a housing further surrounds the stress transfer sleeve. The housing includes at least three stress point apertures symmetrically disposed around its periphery, and a respective number of stress inducers adjustably engaged with the stress point apertures. In a particular aspect, the stress point apertures consist of threaded bores and the adjustable stress inducers are threaded rods that contact the stress transfer sleeve, and which can be turned inward or outward to adjust the stress and thus the stress birefringence on the window.

In another aspect, the symmetric stress birefringence pattern in the window is induced by thermal compression between a housing and the window. According to this aspect, the housing is characterized by a thermal expansion coefficient, γ_{M}, and the window is characterized by a thermal expansion coefficient, γ_{G}, wherein γ_{M} is greater than γ_{G}. At room temperature, the housing has a designed central inner aperture size, Φ_{M}, that is smaller than a designed outer periphery size, Φ_{G}, of the window. However, in a particular elevated temperature range, the housing aperture becomes slightly larger than the window size. In the heated state, the window is disposed within the housing. Upon cooling and stabilization at room temperature, the original size difference creates a desired symmetric stress birefringence pattern in the window.

The polarization converter device outlined in the above aspects can be referred to as a space-variant waveplate.

Another embodiment of the invention is directed to a method for converting spatially homogeneously polarized light into spatially inhomogeneously polarized light that varies in a smooth and continuous manner over a pupil aperture. The method involves the steps of providing a space-variant waveplate as described in the various aspects above, and propagating a beam of the spatially homogeneously polarized light through the waveplate. According to an aspect, the induced symmetric stress birefringence in the window produces a half-wavelength of optical retardance over an annular region centered about an optical axis of the waveplate. According to an aspect, the method involves converting the beam of spatially homogeneously polarized light into a polarization vortex beam upon propagation through the waveplate. According to other aspects, the method involves generating radially and azimuthally polarized cylindrical vector (CV) beams and, further, superpositioning these beams to form polarization vortex beams.

According to another embodiment, an optical imaging system comprises an illumination source that provides spatially homogeneously polarized light along an illumination path, a first space-variant waveplate located in the illumination path on an object side of the system that converts the spatially homogeneously polarized light into a polarization vortex beam upon propagation through the waveplate, a first optical component disposed along the illumination path optically downstream of the waveplate on the object side of the system, an object to be imaged located in a target plane along the illumination path, and an image plane on an image side of the system. In an aspect, the system may further comprise a second optical component located optically downstream of the object on the image side of the system, and a second space-variant waveplate located intermediate the second optical component and the image plane. These aspects of the optical system embodiment may include microscopy systems including, but not limited to, confocal and phase contrast systems; lithography optical systems including, but not limited to, illumination paths of immersion optical lithography systems; semiconductor inspection optical systems; ophthalmic diagnostic and therapeutic optical systems, and other optical system applications requiring improved resolution and/or contrast.

These and other objects, advantages and benefits provided by embodiments of the invention will now be set forth in detail with reference to the detailed description and the drawing figures and as defined in the appended claims.

### BRIEF DESCRIPTION OF THE DRAWINGS

The patent or application file includes at least one drawing executed in color. Copies of this patent or patent application publication with color drawing(s) will be provided by the Office upon request and payment of the necessary fee.

FIGS. 1a and 1b, respectively, illustrate the polarization orientation of an azimuthally and radially polarized beam;

FIGS. 2a and 2b, respectively, illustrate the electric and magnetic fields plotted for the azimuthally (a) and radially (b) polarized beams of FIG. 1;

FIGS. 3a, 3b, 3c and 3d show images of an azimuthally polarized beam where (a) is the beam and (b), (c), and (d) show the beam after passing through a linear polarizer in various orientations;

FIGS. 4a, 4b illustrate a counter-rotating radial beam (a) and a counter-rotating azimuthal beam (b);

FIG. 5 illustrates a radially polarized CV beam formed by combining two HG₁₀ modes of orthogonal polarization;

FIG. 6 illustrates an azimuthally polarized CV beam formed by combining two HG₀₁ modes of orthogonal polarization;

FIG. 7 illustrates a counter-rotating radially polarized beam formed by combining two orthogonal HG₁₀ modes;

FIG. 8 illustrates a counter-rotating azimuthally polarized beam formed by combining two orthogonal HG₀₁ modes;

FIG. 9 illustrates a schematic of a tape-segmented waveplate where the lines within each section mark the fast axis of each segment;

FIG. 10 is a schematic front plan view of a polarization converter according to an embodiment of the invention;

FIG. 11 is a schematic cross sectional side view of a window component of a polarization converter according to an embodiment of the invention;

FIG. 12 is a schematic front plan view of the window component of FIG. 11, showing a continuous, tri-fold, symmetric stress birefringence pattern according to an aspect of the invention;

FIG. 13 is a picture of an actual stress-induced space-variant waveplate according to an embodiment of the invention showing an annular region of λ/2 retardance in a BK7 window due to N=3 stress provided by three set screws;

FIG. 14 is a picture of an actual stress-birefringent polarization converter according to an embodiment of the invention placed between circular polarizers to provide contours of equal retardance, and shows an annular region of λ/2 retardance where the dark band can be observed;

FIG. 15 is a finite element model of an N=3 birefringence converter according to an embodiment of the invention scaled to show an annular region of λ/2 retardance, where the colors correspond to waves of retardation;

FIG. 16a is a plot showing a finite element prediction of birefringence in a stress-induced space-variant waveplate according to an embodiment of the invention;

FIG. 16b depicts arrows of similar lengths that represent regions in FIG. 16a with large amounts of stress;

FIG. 16c depicts arrows of different lengths that represent regions in FIG. 16a with small amounts of stress;

FIG. 17 shows a surface plot of the birefringence according to an exemplary embodiment of the invention;

FIG. 18 shows a plot of the birefringence made by an Exicor Birefringence Mapper;

FIG. 19 shows a plot of the relative magnitude of retardance of an exemplary stress-induced space-variant waveplate;

FIG. 20 shows a plot of the relative index of refraction change of an exemplary stress-induced space-variant waveplate;

FIGS. 21a and 21b show FEA plots of alternative triangular and hexagonal polarization converter window geometries, respectively, according to aspects of the invention;

FIGS. 22a and 22b show an exemplary polarization converter including a hexagonal window and the principal stresses in the window, respectively;

FIG. 23 is a cross sectional elevational view of a polarization converter according to another embodiment of the invention;

FIGS. 24a, 24b show the optical phase retardance characteristics of an exemplary thermal compression stress birefringence polarization converter according to an embodiment of the invention;

FIG. 25 schematically shows the conversion of homogeneously polarized light into inhomogeneously polarized light with a space-variant waveplate according to an embodiment of the invention;

FIG. 26 schematically shows the superposition of an azimuthally polarized beam and a radially polarized beam with a ±π/2 phase difference to create a circularly polarized scalar CV beam according to an embodiment of the invention;

FIG. 27 schematically shows a ‘ratchet beam’ formed by combining an azimuthally polarized beam and a radially polarized beam according to an embodiment of the invention; and

FIGS. 28a, 28b schematically illustrate the generation of radial and azimuthal CV beams from a counter-rotating beam and a λ/2 waveplate.

### DETAILED DESCRIPTION OF A PREFERRED EMBODIMENT OF THE INVENTION

When possible, like reference numerals will be used to describe like parts among the various embodiments of the invention, with reference to the figures.

An embodiment of the invention is directed to a polarization converter that converts spatially homogeneously polarized light into spatially inhomogeneously polarized light having a fast axis orientation that varies in a smooth and continuous manner over a pupil aperture of the device upon propagation through the device.

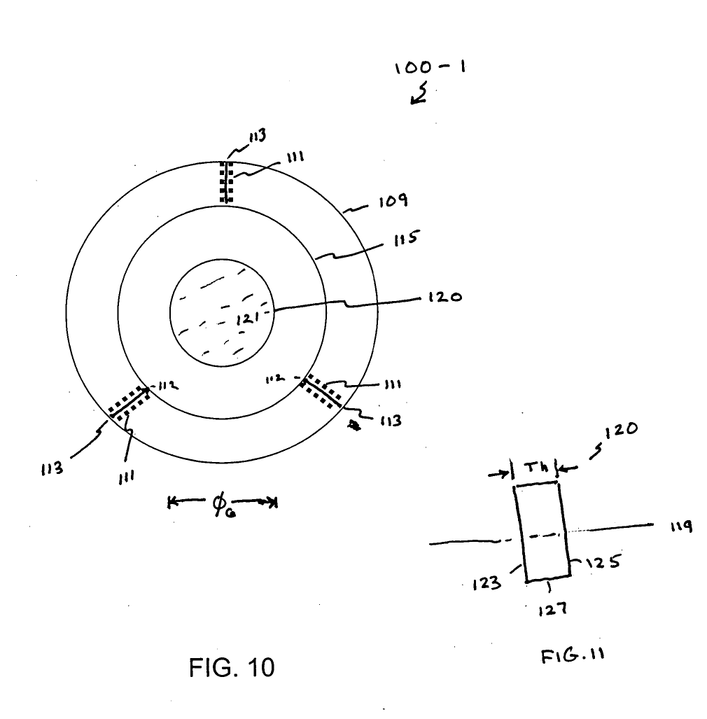

FIG. 10 illustrates a polarization converter 100-1 according to an exemplary embodiment of the invention. The polarization converter 100-1 includes an optically transparent window 120 having a clear aperture 121 defined by opposing, polished faces 123, 125 and a periphery 127 (FIG. 11). In an exemplary aspect, the window 120 is cylindrical, having a diameter, Φ_{G}, equal to 0.5 inches and a thickness, Th, equal to 0.375 inches. The exemplary window 120 is BK7 glass. Fused silica is an alternative window material under investigation. A stress transfer sleeve 115 surrounds and contains the window. The sleeve has a thickness of 0.125 inches and is copper in this example. A housing 109 surrounds and contains the stress sleeve and the window as shown. The housing has three symmetrically positioned threaded bores 111 into which can be screwed three respective set screws 113. In this exemplary aspect, the housing is aluminum. The set screws 113 can be screwed in/out to adjust the amount of force exerted by the tips 112 of the screws on the stress sleeve 115, to induce stress in the window.

When a material such as BK7 glass is subject to stress as illustrated in FIG. 10, for example, stress birefringence can be induced in the material. If the location and amount of stress is controlled as described herein, a smooth, symmetric and continuous stress birefringence pattern 137 as shown in FIG. 12 can be induced over the clear aperture 121 of the window 120. The stress provided by the three symmetrically located set screws 113 create the three-fold birefringence pattern 137. By controlling the magnitude of the stress, the phase retardance in the window can be controlled to produce a λ/2 retardance over an annular region 139 of the window 120.

As an example, if An denotes the birefringence, the relationship required for half wave retardance is
Δnt=(m+½)λ
where t is the thickness of the window, λ is the wavelength of light, and m is an integer. For low stress designs and for designs with broad spectrum applications, m should be 0. The induced birefringence is related to the stress according to the relation
Δn=Kσ
where K is the stress-optical coefficient, and σ denotes the differential stress (difference between the magnitudes of the principal stresses). For BK7 glass, K=2.77 GPa⁻¹; for fused silica, K=3.4 GPa⁻¹. For a typical window thickness of 12.5 mm and red transmission light of wavelength λ=0.631 μm, the required birefringence in the annular region will be 2.5×10⁻⁵. For a BK7 window, the internal stress will be 9 MPa. For fused silica, the internal stress will be 7 MPa.

Because a λ/2 annular area is of interest in generating cylindrical vector beams, as will be described in greater detail below, an apodization pattern is placed on the BK7 window to obscure the central region and outer area. This is variously illustrated in FIGS. 13, 14 and 15. The annular region 139 is centered along the optical axis 119 (FIG. 3) of the window. This annular region may be thought of as a λ/2 waveplate whose fast axis rotates in a smooth and continuous manner while traversing a circular path about the axis 119 of the cylindrical window.

Finite Element Modeling of Stress Birefringence

To understand the mechanics of the stress birefringence converter according to the embodiments set forth herein, a basic understanding of stress is helpfull. Stress is a measure of force per unit area and is represented by σ, which is measured in Pascals, or N/m². When stress is applied to the exterior of a material, atoms are displaced within the material and there is a differential displacement of atoms. If u represents a vector displacement and the partial derivatives of u represent internal forces, which are measured as stress, then the outer product of the gradient operator and the displacement, ∇⊕u, form the stress tensor, represented by the matrix:

$$[ \begin{matrix}{σ}_{xx} & {σ}_{x y} \\ {σ}_{y x} & {σ}_{yy}\end{matrix} ]$$

The stress tensor is directly proportional to the birefringence and, when diagonalized, gives the principal axes. This stress matrix determines the birefringence and the internal stress leads to a change in refractive index of the BK7 window.

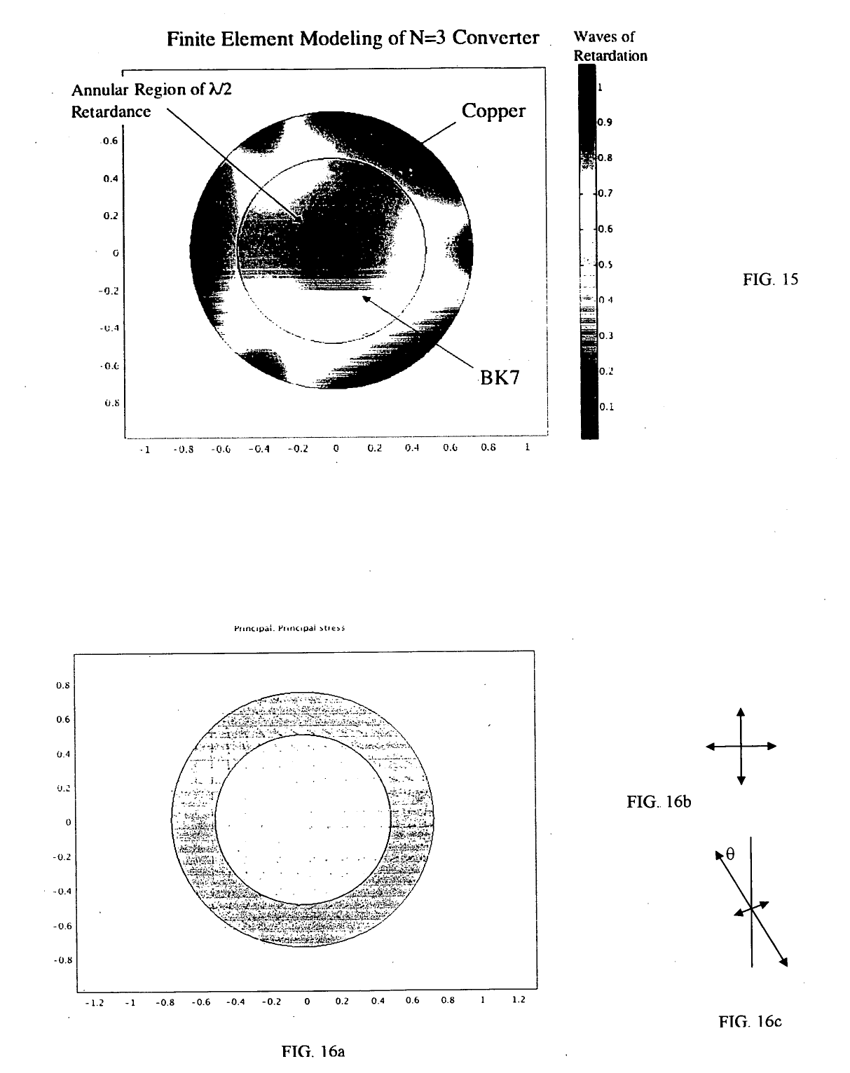

A two-dimensional finite element analysis of the exemplary stress-induced space-variant waveplate converter 100-1 described above was done using FEMLAB software with the assumptions the converter is under linear stress and has a smooth force being applied. FIG. 15 shows a finite element prediction of von Mises Stress distribution, the differential internal forces. The von Mises Stress is a measure of magnitude of stress. In FIG. 15, the outer diameter represents the copper sleeve 115 and the inner region represents the BK7 window 120. From the figure the three locations where the force is applied can be observed. The central part and outer region of the BK7, along with the outer region of the copper, are not of interest because the apodization blocks light from entering those areas of the converter. The annular region of the converter is of particular importance as that is where the λ/2 annulus is located. Within this annular area uniform stress must be applied. By using the FEMLAB analysis program, the amount of applied force can be varied to determine the force that generates a uniform stress in the annular region of interest.

Design issues to be considered for a stress-induced space-variant waveplate, as embodied herein, include predicting and measuring birefringence, absolute index change and surface deformation of the BK7 window. The birefringence of the waveplate can be predicted and analyzed by utilizing mathematical analysis tools including Matlab and FEMLAB, as well as an Exicor Birefringence Mapper from Hinds International. The Exicor Birefringence Mapper can quantify birefringence and determine the fast axis orientation of a sample. Stress-induced surface deformation and an absolute change in index of refraction may result from an applied force, as described above. The optical path length through which light travels in a piece of glass is defined as the summation of index of refraction multiplied by the thickness of the sample. The polarization converter may exhibit wavefront error due to a combination of surface deformation and bulk variation in mean refractive index. Thus any change in absolute index of refraction must be known and surface deformation compensated for. The absolute index change and surface deformation can be observed using, e.g., mathematical analysis programs, as well as interferometers such as a Zygo GPI interferometers, wavefront sensors and other diagnostic metrology apparatus and methods known in the art. To generate cylindrical vector beams, for example, and for other particular applications including, but not limited to, condenser systems and polarization sensitive imaging systems, to be discussed in greater detail below, it may be desirable to reduce this wavefront error such that the stressed, birefringent window transmits a uniform wavefront. Deterministic polishing and finishing, such as magnetorheological finishing (MRF), for example, may be carried out on the front surface of the window. Based upon investigations of the exemplary stress-induced birefringence polarization converter 100-1, the converter exhibited approximately a 0.165 wave peak-to-valley surface deformation over the clear aperture of the window as measured by a Zygo GPI interferometer.

FIG. 16a shows what the FEMLAB model predicts for the magnitude and direction of the birefringence within the exemplary polarization converter 100-1. The central circle represents the BK7 window 120 portion of the converter and the outer ring represents the copper sleeve 115. Again, the area of importance is the annular region within the BK7 window. The arrows in FIG. 16a illustrate the change in absolute index of refraction versus birefringence and show the stress. More particularly, the arrows represent the x and y components of the diagonalized stress matrix. Perpendicular arrows of the same length represent a small change in birefringence and large amounts of stress while perpendicular arrows of very different length represent a large change in birefringence and little stress. FIG. 16b shows a large change in absolute index of refraction, a small change in birefringence, and a large amount of stress. FIG. 16c shows a small change in absolute index of refraction, a large change in birefringence, and a small stress magnitude. From the FEMLAB plot, it can be observed that the applied force does induce the desired, symmetric, continuous stress pattern. The birefringence of the BK7 is significant because it is proportional to stress.

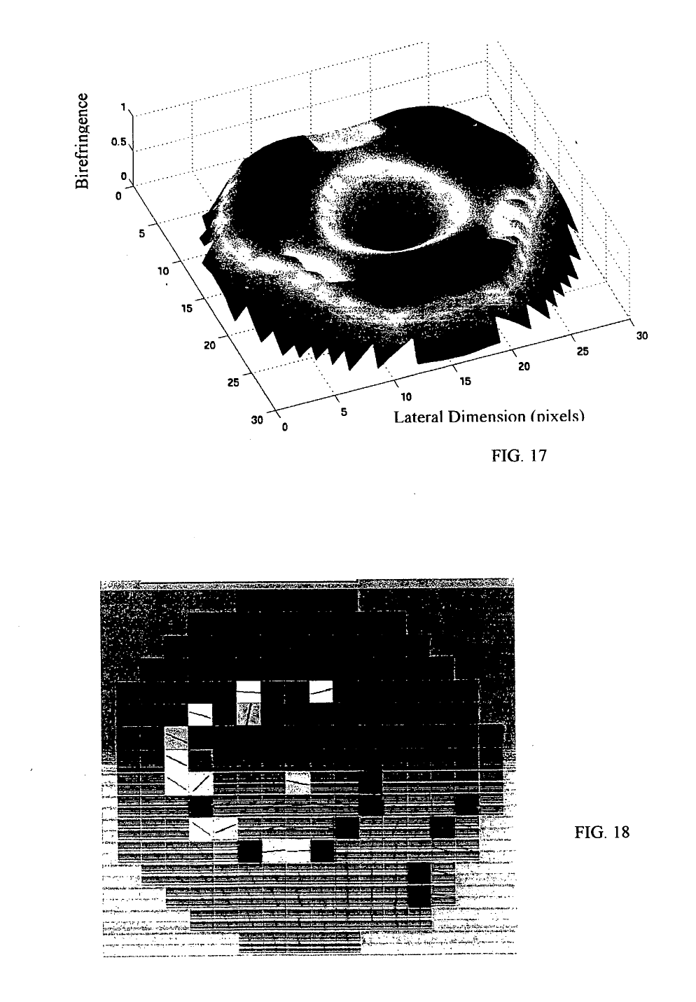

FIG. 17 shows a surface plot of the birefringence in window 120 of exemplary polarization converter 100-1. An annular region is shown having substantially uniform birefringence. Both the central dark region and the exterior portion of the plot are obscured by the apodization referred to above. Quantifying the birefringence of the annulus of the polarization converter at 600 nm with a thickness of 12.5 cm and half-wave retardance gives a birefringence value of 2.4E(−5).

FIG. 18 illustrates a scan of the polarization converter taken on an Exicor Birefringence Mapper. The plot shows the magnitude and direction of the birefringence. The line within each square shows the direction of the fast/slow axis within that specific square portion of the sample. The symmetry of the fast axis about the converter can be observed. The color of the square corresponds to the magnitude of the birefringence within that section of the converter. The brightly colored pixels are bad pixels that arise from an ambiguity in the fast and slow axis between the inside and outside of the λ/2 annulus. These discontinuities in the Birefringence Mapper arise because the instrument loses track of the order of the retardance and starts counting back to zero when it reaches λ/4. The area of interest in the plot is the ring inside of the bad pixels. The FIG. 18 plot shows only the BK7 window 115 under stress and not the copper sleeve.

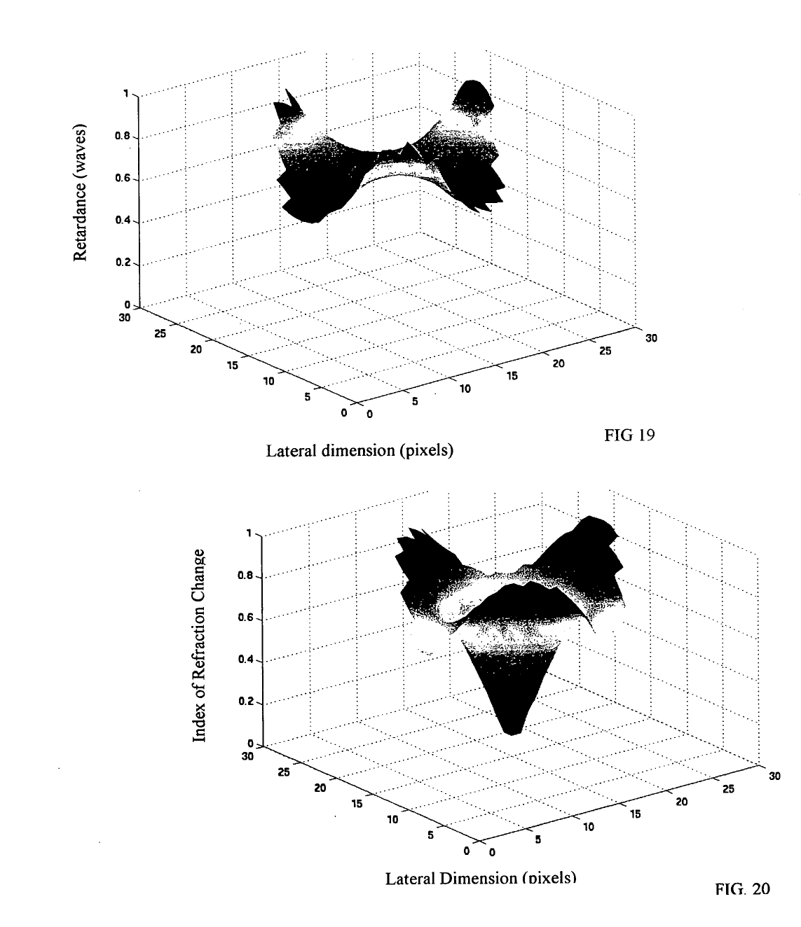

FIGS. 19 and 20 show plots of the relative magnitude of retardance and relative index of refraction change, respectively. The relative birefringence plot provides information about the induced wavefront error. The induced wavefront error can be defined as (Δnₑ+Δnₒ)/2*(t/λ), where Δnₑ is the change in the extraordinary birefringent index of the material, Δnₒ is the change in the ordinary birefringent index of the material, t is the window physical thickness and λ is the wavelength of the propagating light.

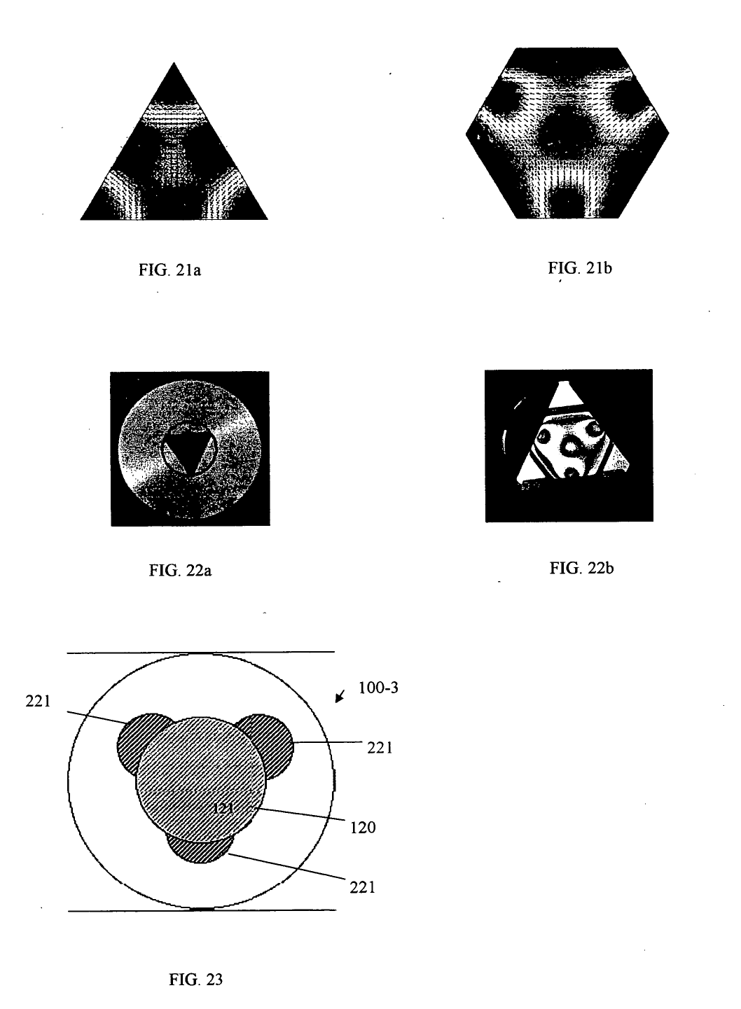

The stress-induced birefringence converter 100-1 has up to now been described as incorporating a window 120 having circular geometry. FIGS. 21a and 21b illustrate two alternate geometries, triangular and hexagonal, that also have been modeled in FEMLAB. The plots show the surface von Mises stress, the principal stress, in both window geometries. The stresses applied are Gaussian distributed forces, not point sources. The plots as shown are linear models. Non-linear models were modeled as well, but showed comparable results. Both the triangular and hexagonal window geometries have an integer multiple of three flat peripheral sides. This is advantageous for producing an N=3-fold symmetric stress birefringence pattern in the window.

FIG. 22a shows a polarization converter 100-2 including a hexagonal window 120-2, rather than a circular window. FIG. 22b shows the principal stresses in the hexagonal window when the converter 100-2 was held between two crossed circular polarizers.

An alternative embodiment to the mechanical compression polarization converter 100-1 discussed above will now be described. FIG. 23 is a schematic front cross sectional view of a thermal compression polarization converter 100-3 according to an exemplary embodiment of the invention. The converter 100-3 includes an optically transparent window 120 having a clear aperture 121 defined by opposing, polished faces 123, 125 and a periphery 127 (FIG. 11). In an exemplary aspect, the window 120 is cylindrical, having a finished outer diameter, Φ_{G}, equal to 0.4938±0.0001 inches and a thickness, Th, equal to approximately 0.08 inches (2 mm). The exemplary window 120 is BK7 glass. Fused silica is an alternative window material under investigation. Other wavelength sensitive optically transparent materials may also be suitable. The window 120 is characterized by a thermal expansion coefficient, γ_{G}. The converter 100-3 also includes compression housing 109-3 having a central aperture defining an inner diameter, Φ_{M}. In the assembled condition, described more fully below, the compression housing surrounds and holds the window in place by a press fit. In an exemplary aspect, the compression housing is made of tool steel and is characterized by a thermal expansion coefficient, γ_{M}, which is greater than γ_{G}. At room temperature, T₀, the housing aperture diameter, Φ_{M}, is smaller than the window outer diameter, Φ_{G}. The housing 109-3 further has a plurality greater than two of relief apertures symmetrically disposed in the housing. As illustrated in FIG. 23, the housing has three relief apertures in the form of semi-apertures 221 whose radii are smaller than the radius of the central aperture in the inner circumferential surface of the housing that defines the central aperture. Since it is advantageous that the window exhibit a three-fold symmetrical stress pattern upon assembly, the number of relief apertures will be 3N, where N is an integer. In the exemplary aspect, N=1.

A brief description of the fabrication process for the exemplary polarization converter 100-3 will clearly illustrate the structural configuration. An initial step in the fabrication process is to cut a center hole through the piece of tool steel housing such that the diameter of the hole is smaller than the diameter of the glass window by 25 microns. Thus for a glass window diameter of 125.000 mm±0.001 mm, the center hole in the tool steel is cut with a diameter of 124.975 mm. The next step in the fabrication process is to machine out three regions of smaller radius within the housing. A cutter, with a radius smaller than the radius of the hole in the tool steel housing, is maneuvered to cut away sections of the inner circumferential surface the housing. The cutter is first placed in the center of the housing aperture. The cutter is then moved in the +y-direction so as to cut away part of the upper section of the inner surface. The cutter is then moved back to the center of the aperture. The cutter is now moved 120° from the upper section of the tool steel hole and cuts away part of the tool steel hole in the lower left section of the aperture. The cutter is then again moved back to the center of the aperture. Finally, the cutter is moved another 120° and cuts away part of the tool steel aperture in the lower right section of the aperture. This process creates three relief apertures in the housing, which will function to provide a symmetric, tri-fold (N=3) stress birefringence pattern in the window. As illustrated in FIG. 23, the central circle 121 represents the central housing aperture. The three semi-circular regions shown as 221 are then machined out so that the central part of the tool steel, where the glass window is to be placed, is not exactly round.

Both the housing and the window are heated to a temperature T>T₀ (T>330° C.) until the housing aperture diameter, Φ_{M}, is larger than the window outer diameter, Φ_{G}, whereupon, the window is inserted into the aperture. Upon cooling, the housing aperture diameter again becomes smaller than the window diameter, providing a press fit as the housing exerts a static stress on the window in the regions where the relief apertures are not machined in the housing.

According to a more general aspect of the thermal polarization converter embodiment, the glass material must be chosen such that the coefficient of thermal expansion for the glass is less than the coefficient of thermal expansion for the metal holder/housing. The type of transparent window material used in the thermal polarization converter can be determined based on three criteria: For use of the thermal polarization converter at very short wavelengths, transparent materials such as fused silica or calcium fluoride may be advantageous. For materials designed for inexpensive optical systems, BK7 appears to be an ideal transparent material. For cases where small forces are required, a material such as Borofloat 33 or Coming 7740 (Borosilicate), for example, could be used for high stress birefringence. Furthermore, relief apertures may advantageously be positioned symmetrically in the body of the housing as long as they serve to provide the housing with at least three symmetric stress exerting regions on the contained window.

It will be appreciated that both the mechanical compression polarization converter embodiment 100-1 (and aspects thereof) and the thermal compression polarization converter embodiment 100-3 (and aspects thereof) will share all of the advantageous optical attributes including, but not limited to, λ/2 retardance over a central annular region in the clear aperture of the window created by a symmetric, continuous stress birefringence pattern having N-fold symmetry, particularly wherein N equals 3.

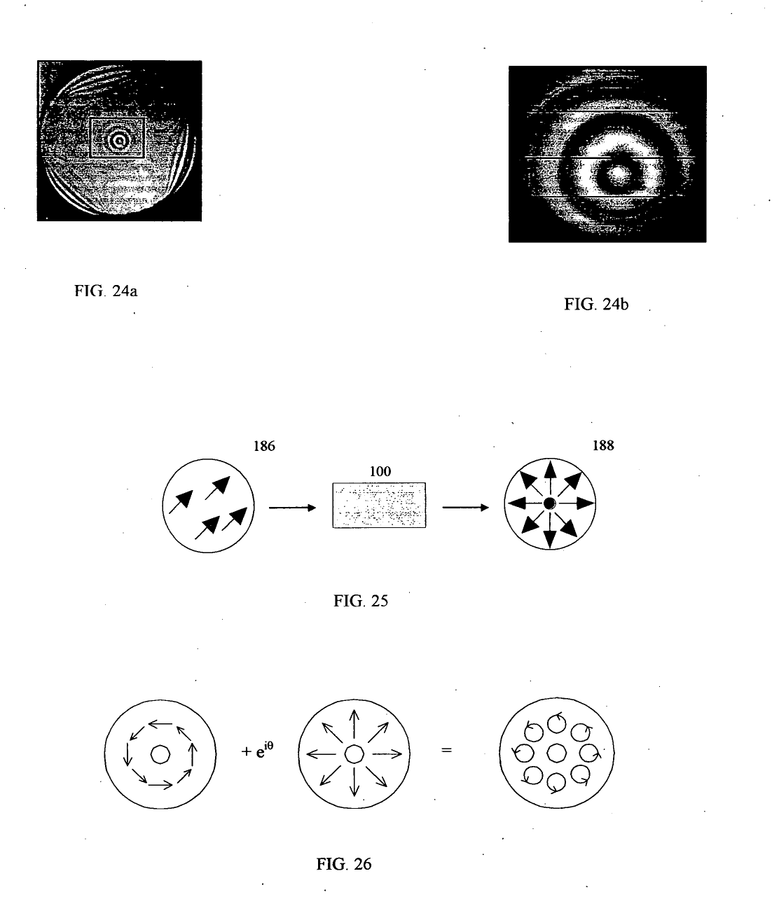

According to another aspect of the foregoing embodiments, a stress-birefringence polarization converter 100-4 that produces mixed vortices is illustrated with reference to FIGS. 24a, 24b. When high N=3 stress is applied at three locations of the window periphery, a mixed vortex beam appears such that multiple annular regions, each with retardance of a multiple of λ/2, are produced, as shown in FIG. 24b. When presented with circularly polarized light, the device produces a transmitted beam having annular regions of alternating right and left circular polarization whose angular momentum varies from zone to zone. It is interest to note that the fringes appear to be equally spaced in contrast to Newton's fringes, which have a thick central fringe and thinner outlying rings.

Having described various exemplary embodiments of a polarization converter, attention is now drawn to a method for converting spatially homogeneously polarized light into spatially inhomogeneously polarized light having a fast axis orientation that varies in a smooth and continuous manner over a pupil aperture.

In the following examples, spatially inhomogeneously polarized light having a fast axis orientation that varies in a smooth and continuous manner over a pupil aperture is obtained by propagating spatially homogeneously polarized light through a space-variant waveplate as described above including a windowed clear aperture that provides a λ/2 retardance in an annular region generally centered about the optical axis of the waveplate. Because of the annular nature of the optical region of interest, at least a central obscuration of the window is provided to block out the central null or vortex region. More particularly, the clear aperture outside of the optical annular region is also obscured.

Previously known techniques and apparatus used to convert a beam of uniform polarization into a beam of inhomogeneous polarization do so by dividing the beam into individual segments, in a discrete manner. Use of the polarization converter embodiments described herein provides polarization conversion from a beam of uniform polarization to one of inhomogeneous polarization which varies over the pupil in a smooth and continuous manner. If the stress birefringence symmetry is chosen to be N=3 (tri-fold symmetry), the annular region will have a smoothly varying principal stress direction which, in turn, achieves a smoothly varying birefringence. To achieve best conversion performance, the end faces of the transparent window material should be polished and the window mounted in the apparatus in such a way that the window transmits a planar wavefront while under stress. FIG. 25 schematically shows the conversion of homogeneously polarized light 186 into inhomogeneously polarized light 188 with the space-variant waveplate 100.

In order to achieve the various homogeneous-to-inhomogeneous polarization conversions, a source component or system is provided that outputs linear, circular or elliptically oriented plane polarized light. Exemplary sources include low coherence lasers, LEDs and other known low coherence sources.

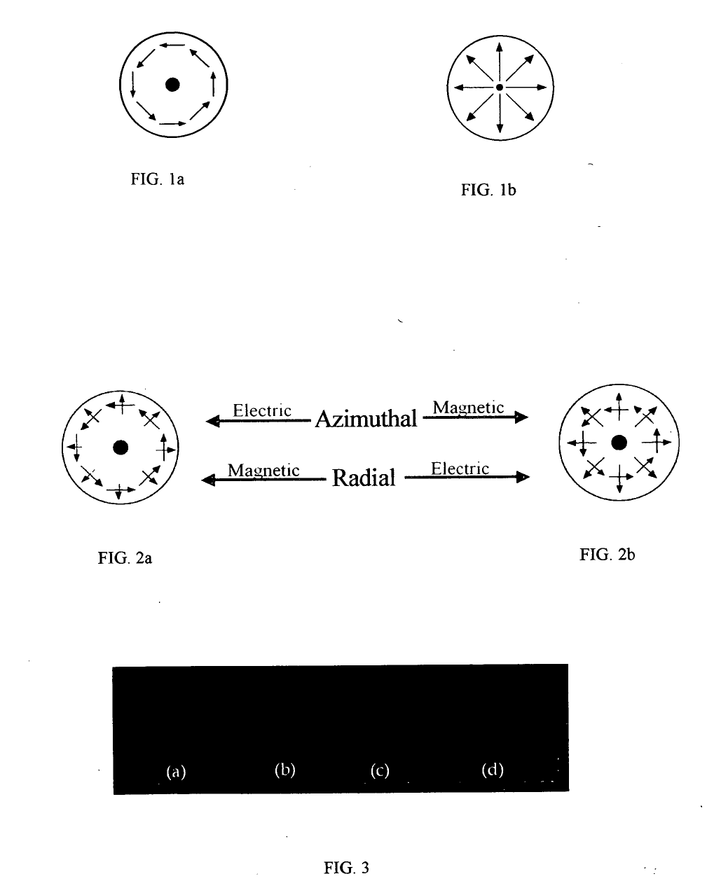

In one exemplary aspect, linearly polarized light having its fast axis oriented vertically is propagated through the N=3 polarization converter. A radially polarized vortex beam as illustrated in FIG. 1b can thus be produced. In another aspect, an azimuthally polarized vortex beam as illustrated in FIG. 1 a can be produced by orienting the fast axis of the linearly polarized input beam in a horizontal direction. Radial and azimuthal vortex polarizations are examples of two lowest-order optical vortex beams. Cylindrical vector (CV) beams are a class of polarization vortex beams. While conventional beams are low-order and of Gaussian shape, CV beams correspond to higher order modes of the field. Linear combinations of the radial and azimuthal vortex beams can provide a variety of other polarization patterns.

As illustrated in FIG. 26, a circularly polarized scalar vortex beam 310 is formed by combining an azimuthally polarized beam 307 and a radially polarized beam 309 with a ±π/2 phase difference (represented at 311) between the two beams.

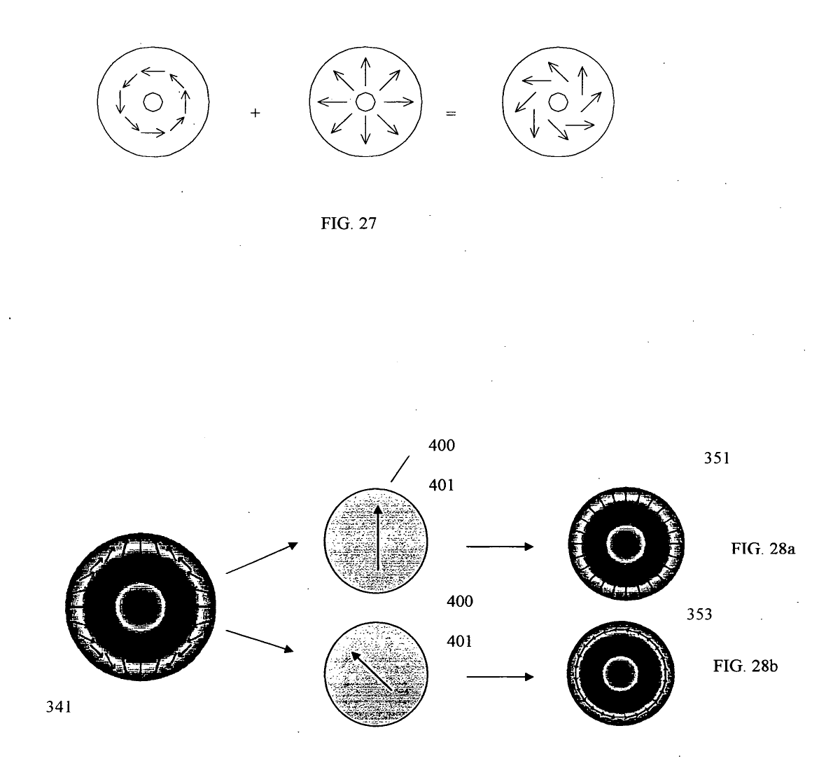

As shown in FIG. 27, the superposition of an azimuthally polarized beam 307 and a radially polarized beam 309 produces a CV beam that may best be described as a ‘ratchet mode’ beam 312.

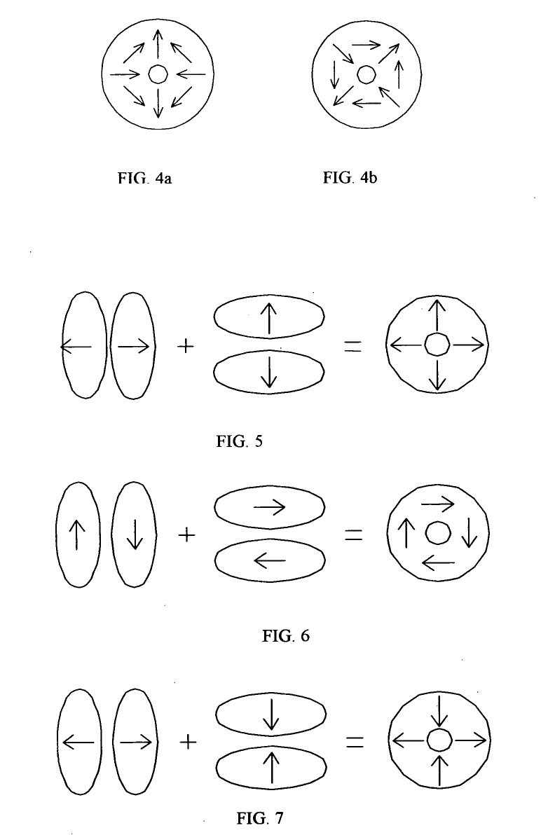

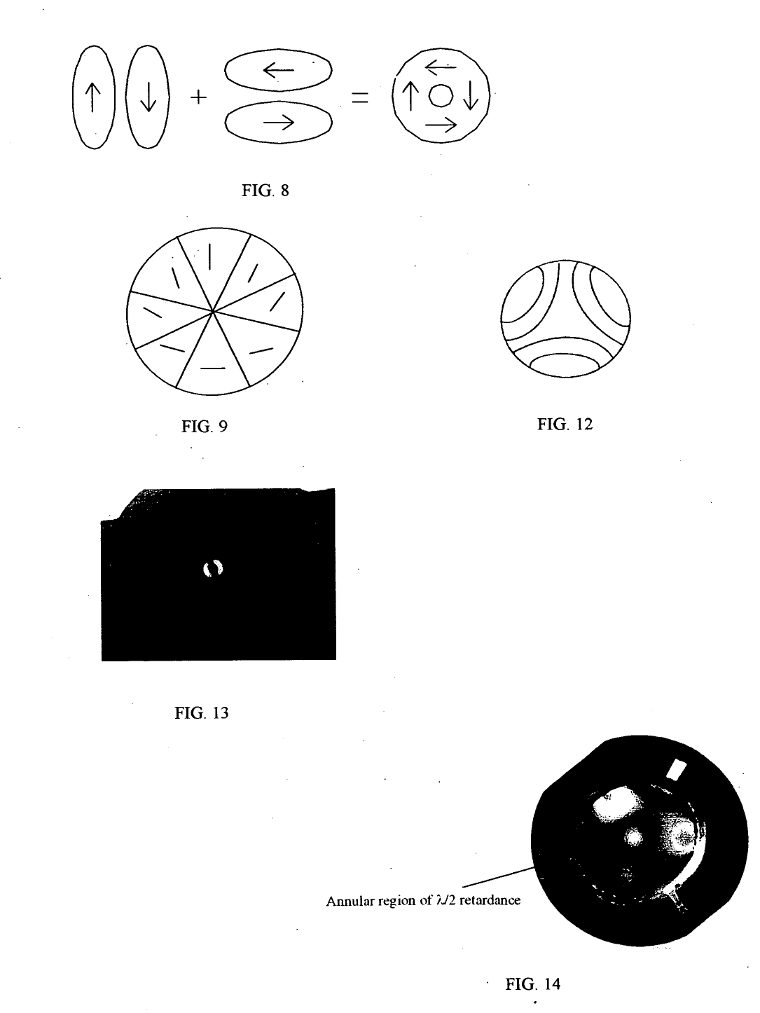

Another type of polarization vortex beams, called ‘counter-rotating’ beams as shown in FIGS. 4a, 4b, can also be created. FIG. 4a shows a counter-rotating radial beam 331; FIG. 4b shows a counter-rotating azimuthal beam 333. These counter-rotating beams are inhomogeneously polarized but are not considered cylindrical vector beams.

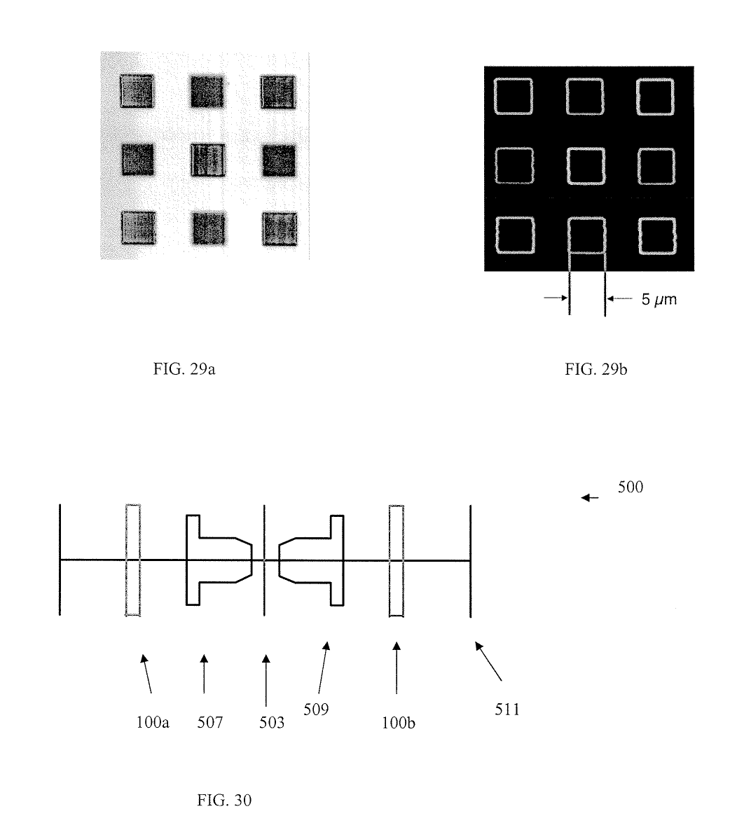

The counter-rotating beams referred to immediately above can be utilized to create radial and azimuthal cylindrical vector polarizations with the addition of a half-waveplate as illustrated in FIGS. 28a, 28b. As shown in FIG. 28a, a radial CV polarization beam 351 results when a counter-rotating beam 341 is propagated through a stress-induced space-variant polarization converter (not shown) placed with a half-waveplate 400 oriented such that the fast axis 401 of the half-waveplate is in the vertical direction. Referring to FIG. 28b, an azimuthally polarized CV beam 353 is created when the half-waveplate is positioned with its fast axis at 45 degrees.

Embodiments of the polarization converter device and polarization conversion methods, as described herein, can be used in a variety of optical imaging system applications including, but not limited to, various types of microscopy, optical lithography including reticle and mask design, semiconductor inspection, ophthalmology and others that persons skilled in the art will appreciate.

In an optical system the illumination system is paramount. By optimizing the illumination design, optical resolution of an imaging system can be enhanced. This can be accomplished, at least in part, through precise engineering of polarization distribution in the pupil as well as polarization coherence. In recent years, it has become clear that pupil illumination with a polarization that varies spatially and in a continuous manner throughout the pupil offers potential advantages in imaging including higher resolution and higher longitudinally polarized fields at the focus of the condenser. It is known in the art that the longitudinal component of a radially polarized beam has a smaller focal spot than a linearly polarized beam for beams focusing at high numerical aperture (NA) values. Radially polarized beams possess a localized, intense field component that is polarized longitudinally, or in the direction of propagation, through the focus. Radially polarized CV beams also possess a less intense radially polarized component. The longitudinal field at focus from a radially polarized beam can be used to perform imaging with increased resolution. A radially polarized beam creates a significantly stronger longitudinal field than a uniformly polarized beam near focus, so by choosing an appropriate mechanism that interacts exclusively with the longitudinal component of a radially polarized beam, the point spread function can be reduced and the resolution of the system increased.

CV beams can be used to perform dark-field, or differential phase contrast, imaging. In this mode of imaging, edges are bright while flat surfaces are dark. FIGS. 29a, 29b show a phase mask illuminated with linearly polarized light in bright-field mode (a), and the same phase mask illuminated with radially polarized light in dark-field mode (b). In dark-field imaging light that is scattered from a surface is collected, while in bright-field imaging light that is specularly reflected is collected. For bright-field imaging, planar surfaces appear bright and scattered objects, such as edges, appear dark. For dark-field imaging, the reverse is true; edges and scattering objects are bright and planar surfaces are dark. Dark-field imaging can offer potentially higher contrast than bright-field imaging. For dark-field imaging the central part of the beam is obscured to enhance the shape and contour of objects.

Embodiments of the stress birefringence polarization converter described herein above have been used in a variety of preliminary imaging configurations. According to an exemplary system, the object being imaged is an Air Force target with finest lines having a thickness of 4 μm separated by 2 μm. We believe that imaging with a finer Air Force target having 5121 p/mm will soon be achieved. Proposed exemplary imaging configurations involve imaging with one polarization converter on the condenser side of the optical system; and, also imaging with two converters in the system, one converter on the condenser side and one converter on the imaging side as illustrated by the system 500 in FIG. 30. The system includes object target 503, microscope objectives 507, 509 located, respectively, one focal length away on object and image sides of the object, one stress birefringence polarization converter 100_{A} on the object side and another stress birefringence polarization converter 100_{B} on the image side, and an image plane 511. With one converter on the condenser side, a high numerical aperture microscope objective can be used. Imaging with two converters allows for dark-field imaging. In an exemplary aspect, the imaging objective will have 10× magnification and a numerical aperture of 0.25. Images will be gathered with a condenser objective with the same magnification and numerical aperture. Additional images will be gathered with a condenser objective with 5× magnification and a 0.10 numerical aperture.

Another optical system aspect according to an embodiment of the invention is directed to optical lithography. Optical lithography provides a high-productivity, profitable means for making microcircuits on semiconductor wafers. Through the use of higher numerical aperture illumination optics (including immersion techniques providing NAs of 1.2 or more), shorter illumination wavelengths (e.g., 193 nm), and resolution enhancement techniques utilizing, for example, azimuthally polarized CV beams, lithography systems are moving forward into the sub-50 nm regime. Immersion lithography, in fact, is approaching a regime of extreme-NA potentially creating a polarization orientation-dependent impact on imaging. Immersion lithography provides increased depth of field while requiring polarization control. The precise use of illumination polarization that can be generated by the stress-induced space-variant waveplate (polarization converter) embodiments described herein will likely have a significant, positive impact on projection lithography. To this end, stress birefringence polarization converters in fused silica are being modeled and tested. Engineering efforts directed to next generation lithography are focusing on polarization distribution in the pupil as well as polarization coherence at the reticle.

In a further exemplary aspect, the polarization converter that generates cylindrical vector beams can be used in an optical system for semiconductor inspection. For inspection, mask and wafer metrology remain extremely difficult challenges. The stress birefringence polarization converter is significant because the proper engineering of optical polarization and coherence in illumination design remains essential in semiconductor inspection systems. Both radial and azimuthal polarizations produced by the stress birefringence polarization converter allow a dark-field mode of imaging that is suitable for alt-PSM reticle inspection and sensitive particle detection. Moreover, using cylindrical vector beam microscopy, distinguishing between a metal nanoparticle and a crystal-originated pit is possible because cylindrical vector beams lend themselves toward preferred axes of a molecule or particle. This may have additional application to biological microscopy.

Another aspect of the optical system application is directed to ophthalmic imaging. Ophthalmic imaging with a stress birefringence polarization converter according to an embodiment of the invention can be done with a transmission microscope, a reflection microscope or by placing the stress birefringence polarization converter directly in front of a subject's eye to increase the contrast of photoreceptors and further elucidate modal structures. The stress birefringence polarization converters described herein can be utilized in ophthalmic imaging for both bright-field and dark-field system configurations. The implementation of adaptive optics has been used to correct for the eye's aberrations. Even with the use of adaptive optics, foveal cones are still difficult to resolve and, currently, rods are unable to be resolved. Rods are at the center of the majority of retinal diseases, so the ability to resolve rods is of great importance and utility. Different parts of the eye have varying polarizations. Previous research has shown specific parts of the eye can be isolated with specific polarizations. The use of polarization accompanied with ophthalmic imaging is a means to study retinal diseases. There are two properties of cylindrical vector beams which are of relevance to the imaging of photoreceptors: 1) focused cylindrical vector beams provide a strong longitudinal field component at the object; 2) in contrast to conventional beams, which tend to be low-order and of a Gaussian shape, CV beams correspond to higher-order modes of the field and therefore couple to different modes of waveguide-like cylindrical structures. Microscopy requires that illumination be scattered by the object. For small structures, the scattering efficiency (measured by the polarizability) is proportional to the particle size in the direction of the polarization at focus. For cylindrical structures, the particle will therefore scatter axial field components with a strength proportional to the cylinder length. Transverse fields will scatter with a strength proportional to the transverse dimension of the cylinder. The cylindrical structures of the photoreceptors lend themselves naturally to the scattering of the longitudinal fields which exist in the focus of a CV beam. Because cylindrical vector beams comprise higher order modes, performing differential imaging, in which the image formed by a radially polarized beam is subtracted from an image formed by a linearly or circularly polarized beam, can provide greater information about photoreceptors and improve the contrast in retinal imaging.

Having thus described the various embodiments of the invention, it will be apparent to those skilled in the art that the foregoing detailed disclosure is presented by way of example only and thus is not limiting. Various alterations, improvements and modifications recognized by those skilled in the art, though not expressly stated herein, may be made and are intended to be within the spirit and scope of the claimed invention. Additionally, the recited order of processing elements or sequences, or the use of numbers, letters, or other designations, is not intended to limit the claimed processes to any order except as may be specified in the claims. Accordingly, embodiments of the invention are limited only by the following claims and equivalents thereto.

### NUMBERED REFERENCES

[1] D. G. Hall, “Vector-beam solutions of Maxwell's wave equation,” Opt. Lett. 21, 9-11 (1996).
[2] R. H. Jordan and D. G. Hall, “Free-space azimuthal paraxial wave equation: The azimuthal Bessel-Gauss beam solution,” Opt. Lett. 19, 427-429 (1994).
[3] P. L. Greene and D. G. Hall, “Diffraction characteristics of the azimuthal Bessel-Gauss beam,” J. Opt. Soc. Am. A 13, 962-966 (1996).
[4] P. L. Greene and D. G. Hall, “Properties and diffraction of vector Bessel-Gauss beams,” J. Opt. Soc. Am. A 15, 3020-3027 (1998).
[5] P. L. Greene and D. G. Hall, “Focal shift in vector beams,” Opt. Exp. 4, 411-419 (1999).
[6] C. J. R. Sheppard and S. Saghafi, “Transverse-electric and transverse-magnetic beam modes beyond the paraxial approximation,” Opt. Lett. 24, 1543-1545 (1999).
[7] P. L. Greene and D. G. Hall, “Focal shift in vector beams,” Opt. Exp. 4, 411-419 (1999).
[8] K. S. Youngworth and T. G. Brown, “Focusing of high numerical aperture cylindrical vector beams,” Optics Express 7(2), 77-87 (2000).
[9] D. P. Biss and T. G. Brown, “Cylindrical vector beam focusing through a dielectric surface,” Opt. Exp. 9, 490-497 (2001).
[10] S. Quabis, R. Dom, M. Eberler, O. Glockl, and G. Leuchs, “Focusing light to a tighter spot,” Opt. Comm. 179, 1-7 (2000).
[11] S. Quabis, R. Dom, M. Eberler, O. Glockl, and G. Leuchs, “The focus of light-theoretical calculation and experimental topographic reconstruction,” Appl. Phy. B 72, 109-113 (2001).
[12] D. P. Biss, “Focal field interactions from cylindrical vector beams,” Ph.D. thesis, University of Rochester, Rochester, N.Y. 14627 (2005).
[13] L. Novotny, M. R. Beversluis, K. S. Youngworth and T. G. Brown, “Longitudinal field modes probed by single molecules,” Phys. Rev. Lett. 86, 5251-5253 (2001).
[14] D. P. Biss, K. S. Youngworth and T. G. Brown, “Longitudinal field imaging,” in Proceedings of the SPIE—The International Society for Optical Engineering, vol. 4964 of Three-Dimensional and Multidimensional Microscopy: Image Acquisition and Processing X, 73-87 (2003).
[15] T. Erdogan, O. King, W. Wicks, D. G. Hall, E. H. Anderson, and M. J. Rooks, “Circularly symmetrical operation of a concentric-circle-grating, surface-emitting, AlGaAs/GaAs quantum-well semiconductor-laser,” Applied Physics Letters 60, 1921 (1992).
[16] E. G. Churin, J. Hossfeld, and T. Tschudi, “Polarization configurations with singular point formed by computer-generated holograms,” Opt. Comm. 99, 13-17 (1993).
[17] M. Stalder and M. Schadt, “Linearly polarized light with axial symmetry generated by liquid-crystal polarization converters,” Opt. Lett. 21, 1948-1949 (1996).
[18] T. Grosjean, D. Courjon, and M. Spajer, “An all-fiber device for generating radially and other polarized light beams,” Opt. Comm. 203(1-2), 1-5 (2002).
[19] K. S. Youngworth, “Inhomogeneous polarization in confocal microscopy,” Ph.D. thesis, University of Rochester, Rochester, N.Y. 14627 (2002).
[20] K. S. Youngworth and T. G. Brown, “Point spread functions for particle imaging using inhomogeneous polarization in scanning optical microscopy,” Proc. SPIE 4261, 14-23 (2001).
[21] M. Spencer, Fundamentals of Light Microscopy, (Cambridge University Press, Cambridge 1982), p. 37-38.
[22] S. Inoue and R. Oldenbourg, Handbook of Optics, edited by M. Bass (McGraw-Hill, Inc., New York, 1995), vol. II, ch. 17, p. 25.
[23] D. Flagello, B. Geh, S. Hansen, and M. Totzeck, “Polarization effects associated with hyper-numerical-aperture (>1) lithography,” J. Microlith., Microfab., Microsyst. 4(3), 031104 (2005).
[24] K. Adam and W. Maurer, “Polarization effects in immersion lithography,” J. Microlith., Microfab., Microsyst. 4(3), 031106 (2005).
[25] A. Estroff, Y. Fan, A Bourov, and B. Smith, “Mask-induced polarization effects at high numerical aperture,” J. Microlith., Microfab., Microsyst. 4(3), 031107 (2005).
[26] B. Smith and J. Cashmore, “Challenges in high NA, polarization, and photoresists,” Proc. SPIE 4691, (2002).
[27] G. McIntyre and A. Neureuther, “Phase-shifting mask polarimetry: monitoring polarization at 193-nm high numerical aperture and immersion lithography with phase shifting masks,” J. Microlith., Microfab., Microsyst. 4(3), 031103 (2005).
[28] R. French, H. Sewell, et al., “Imaging of 32-nm 1:1 lines and spaces using 193-nm immersion interference lithography with second-generation immersion fluids to achieve a numerical aperture of 1.5 and a k1 of 0.25,” J. Microlith., Microfab., Microsyst. 4(3), 031102 (2005).
[29] B. Smith, L. Zavyalova, and A. Estroff, “Benefitting from polarization—effects on high-NA imaging,” Proc. SPIE 5377, 68-79 (2004).
[30] D. P. Biss, K. S. Youngworth, T. G. Brown, “Dark-field imaging with cylindrical-vector beams,” Appl. Opt. (to be published).
[31] D. G. Flagello, B Arnold, S. Hansen, M. Dusa, R. Socha, J. Mulkens, and R. Garreis, “Optical lithography in the sub-5-nm regime,” Proc. SPIE 5377, 21-33 (2004).

We claim:

1. A polarization converter, comprising:
an optically transparent window having a clear aperture defined by opposing, polished faces and a periphery, wherein the window has an induced symmetric stress birefringence over at least a portion of the clear aperture sufficient to produce an optical retardance equal to or greater than a quarter wavelength, further wherein the stress birefringence is characterized by a continuous pattern having N-fold symmetry, wherein N is an integer greater than 2.

2. The polarization converter of claim 1, wherein N=3, which defines a tri-fold symmetry pattern.

3. The polarization converter of claim 1, wherein the window is cylindrical.

4. The polarization converter of claim 1, wherein the window periphery has S flat regions, where S is an integer multiple of 3.

5. The polarization converter of claim 1, wherein the opposing, polished faces are characterized by an optical quality sufficient to transmit a plane wavefront.

6. The polarization converter of claim 1, wherein a selected region on the opposing faces have a surface figure equal to or less than λ/10.

7. The polarization converter of claim 6, wherein a selected region on the opposing faces have a surface figure equal to or less than λ/20.

8. The polarization converter of claim 1, wherein the optical retardance is a half-wavelength.

9. The polarization converter of claim 8, wherein the half-wavelength retardance is over an annular region centered about an optical axis of the window.

10. The polarization converter of claim 9, wherein the annular region exhibits a smoothly varying principal stress direction such that the stress birefringence varies smoothly.

11. The polarization converter of claim 9, wherein the annular region exhibits a fast polarization axis that rotates in a smooth and continuous manner over a circular path centered about the optical axis.

12. The polarization converter of claim 1, characterized in that an input beam of spatially homogeneously polarized light is converted to an output beam of inhomogeneously polarized light.

13. The polarization converter of claim 12, wherein the spatially homogeneously polarized input light is linearly polarized.

14. The polarization converter of claim 12, wherein the spatially homogeneously polarized input light is circularly polarized.

15. The polarization converter of claim 12, wherein the spatially homogeneously polarized input light is elliptically polarized.

16. The polarization converter of claim 1, wherein the window is glass.

17. The polarization converter of claim 16, wherein the window is BK7.

18. The polarization converter of claim 16, wherein the window is fused silica.

19. The polarization converter of claim 9, wherein the window includes an apodization pattern that obscures a central region inside the annular region and a region outside of the annular region.

20. The polarization converter of claim 1, further comprising a stress transfer sleeve surrounding the window periphery and a housing surrounding the stress transfer sleeve.

21. The polarization converter of claim 20, wherein the housing has a plurality of stress point apertures symmetrically disposed therein, and a respective plurality of stress inducers adjustably engaged with the stress point apertures.

22. The polarization converter of claim 21, further wherein an end of a stress inducer contacts the stress transfer sleeve.

23. The polarization converter of claim 1, further comprising a compression housing surrounding the window, wherein the housing is characterized by a thermal expansion coefficient, γ_{M}, and the window is characterized by a thermal expansion coefficient, γ_{G}, wherein γ_{M} is greater than γ_{G}.

24. The polarization converter of claim 23, wherein, at room temperature, T₀, the housing has an inner diameter defining a central aperture having a diameter, Φ_{M}, that is smaller than an outer diameter, Φ_{G}, of the window and, further wherein, at a temperature T>T₀, Φ_{M}>Φ_{G}.

25. The polarization converter of claim 24, wherein at T₀, the diameter, Φ_{M}, is smaller than the window diameter, Φ_{G}, by between about 15 microns to 35 microns.

26. The polarization converter of claim 24, wherein the diameter, Φ_{M}, is smaller than the window diameter, Φ_{G}, by about 25 microns.

27. The polarization converter of claim 24, wherein the housing further comprises a 3N (N=1, 2, 3, . . . ) plurality of relief apertures symmetrically disposed in the housing.

28. The polarization converter of claim 27, wherein the plurality of relief apertures are semi-apertures in an inner circumferential surface of the housing that defines the central aperture.

29. The polarization converter of claim 27, wherein N=1.

30. The polarization converter of claim 23, wherein the window is disposed in the housing by a symmetric stress-inducing friction fit.

31. A method for converting spatially homogeneously polarized light into spatially inhomogeneously polarized light having a fast axis orientation that varies in a smooth and continuous manner over a pupil aperture, comprising:
providing a space-variant waveplate including a windowed clear aperture characterized by a symmetric stress birefringence over at least a portion of the clear aperture that provides at least a quarter-wavelength of optical retardance over the at least a portion of the clear aperture; and
propagating a beam of the spatially homogeneously polarized light through the portion of the clear aperture.

32. The method of claim 31, wherein the symmetric stress birefringence produces a half-wavelength of optical retardance over an annular region centered about an optical axis of the space-variant waveplate.

33. The method of claim 31, comprising converting the beam of the spatially homogeneously polarized light into a polarization vortex beam upon propagation through the waveplate.

34. The method of claim 31, wherein the spatially homogeneously polarized input light is linearly polarized.

35. The method of claim 31, wherein the spatially homogeneously polarized input light is circularly polarized.

36. The method of claim 31, wherein the spatially homogeneously polarized input light is elliptically polarized.

37. The method of claim 33, wherein the polarization vortex beam is a cylindrical vector beam.

38. The method of claim 37, wherein the cylindrical vector beam is characterized by a radial polarization pattern.

39. The method of claim 37, wherein the cylindrical vector beam is characterized by an azimuthal polarization pattern.

40. The method of claim 37, further comprising:
generating a radially polarized beam and an azimuthally polarized beam; and
combining the radially polarized beam and the azimuthally polarized beam in a manner to generate at least one of a circularly polarized scalar vortex beam and a ratchet mode beam scalar vortex beam.

41. The method of claim 33, wherein the polarization vortex beam is at least one of a radially polarized counter-rotating beam and an azimuthally polarized counter-rotating beam.

42. The method of claim 41, further comprising:
providing a half-wave waveplate having a fast optical axis; and
propagating the radially polarized counter-rotating beam through the half-wave waveplate, so as to produce a cylindrical vector output beam.

43. The method of claim 42, further comprising orienting the fast optical axis of the half-wave waveplate in a vertical direction so as to generate a radially polarized cylindrical vector output beam.

44. The method of claim 42, further comprising orienting the fast optical axis of the half-wave waveplate at an angle of 45 degrees with respect to the vertical direction so as to generate an azimuthally polarized cylindrical vector output beam.

45. An optical system for improved resolution imaging of an object, comprising:
an illumination source that provides spatially homogeneously polarized light along an illumination path;
a first space-variant waveplate located in the illumination path on an object side of the system that converts the spatially homogeneously polarized light into a polarization vortex beam upon propagation there through;
a first optical component disposed along the illumination path optically downstream of the waveplate on the object side of the system;
an object to be imaged located in a target plane along the illumination path; and
an image plane on an image side of the system.

46. The optical system of claim 45, wherein the illumination source includes at least one of a low coherence laser and a light emitting diode.

47. The optical system of claim 45, wherein the object is located in a focal plane of the first optical component.

48. The optical system of claim 45, comprising an immersion lithography optical system.

49. The optical system of claim 48, wherein the object is a lithographic circuit mask.

50. The optical system of claim 45, further comprising:
a second optical component located optically downstream of the object on the image side of the system; and
a second space-variant waveplate located intermediate the second optical component and the image plane.

51. The optical system of claim 50, wherein the system is a confocal microscopy imaging system.

52. The optical system of claim 51, wherein the system is a dark field imaging system.
